(19) United States
(12) Patent Application Publication
(10) Pub. No.: US 2008/0135804 A1
(43) Pub. Date: Jun. 12, 2008

(54) All-in-one organic electroluminescent inks with balanced charge transport properties

(76) Inventors: Chunong Qiu, Brossard (CA); Steven Shuyong Xiao, Laval (CA); Cindy X. Qiu, Brossard (CA)

Correspondence Address: Cindy X. Qiu, 6215 Bienville St., Brossard, QC, J4Z 1W6, omitted

(21) Appl. No.: 11/635,445

(22) Filed: Dec. 8, 2006

(51) Int. Cl. C09K 11/06

(52) U.S. Cl. 252/301.16

(57) ABSTRACT

The present invention discloses all-in-one organic electroluminescent inks for balanced charge injection. When of single layer organic lighting emitting diodes are made from these inks, the charge balance can be readily achieved. By using the invented all-in-one organic electroluminescent inks, both the device structure and the fabrication process are simplified, which will increase the production yield and reduce the production cost in manufacturing such devices. This invention also teaches methods to fabricate single layer all-in-one organic light emitting diodes.

### FIELD OF THE INVENTION

This invention relates to organic semiconductor devices for optoelectronic applications. More specifically, it relates to all-in-one organic electroluminescent inks with balanced charge injection for single-layer organic light emitting device fabrication.

### BACKGROUND OF THE INVENTION

Organic light emitting diode (OLED) in flat panel display (FPD) applications offers advantages of bright color, high contrast, wide view angle, high energy efficiency, light weight and small thickness.

The commercialization of current OLED technology is driven by the earlier invention of Tang et al (U.S. Pat. Nos. 4,769,292 and 4,885,211, where a three layer OLED composing of a hole-transporting layer (HTL), an organic light-emitting layer (LEL) and an electron-transporting layer (ETL) was disclosed). Since this invention, more layers of materials with different functionalities are added to this three layer device structure to improve its performance in color, stability, luminance and efficiency. These added layers are hole injection layer (HIL), electron injection layer (EIL), electron blocking layer (EBL), hole blocking layer (HBL) and exciton blocking layer. Despite these development works, OLED has achieved limited success in flat panel display (FPD) marketplace due to its high production cost and low production yield.

The high production cost and low production yield are direct consequences of two problems associated with the OLED technology. One problem is complexity of the device configuration. While improving the performance of the multilayer OLED configuration, researchers are introducing more layers of materials into this configuration and making the structure even more complex. Furthermore, the thickness of each layer needs to be precisely controlled in order to have the desired performance. Fabrication of such complicated multiplayer devices is often tedious, difficult and expensive.

The second problem of the multilayer OLED technology is high cost and low yield of the fabrication process. The current multilayer OLEDs are almost exclusively fabricated under a vacuum atmosphere by various vacuum deposition techniques. To set-up and maintain a high vacuum in working condition is very costly. Furthermore, the vacuum deposition rate is low.

As an overall consequence of these two problems, a huge initial capital investment on machinery is always involved to start any OLED production line. Furthermore, the production throughput is generally low and the production capability is limited by the size of the vacuum chambers involved. All these add into the cost of the final product, making this technology less competitive with the existing technologies such liquid crystal display (LCD), and plasma display panel (PDP) in flat panel display (FPD).

Light emitting from an OLED device is the result of recombination of positive charges (holes) and negative charges (electrons) inside an organic compound layer. The released recombination energy is then absorbed by the organic material and sequentially generates excitons. When the organic molecules release the required energy and return to its stable state, photons are generated. This organic compound is referred as an electro-fluorescent material or electro-phosphorescent material depending on the nature of the radiative process. In this application, we generally refer these materials as light emitting materials or more scientifically as electro-luminescent materials (ELM). The emitted color is determined by the energy gap of the light emitting materials. The energy gap is defined as the energy difference between the highest occupied molecular orbit (HOMO) and the lowest un-occupied molecular orbit (LUMO) of the molecule.

Theoretically, if a light emitting material is sandwiched between two electrodes to form a thin pin-hole free layer and a bias voltage is applied to this layer through the two electrodes, the electrons from the negative electrode (cathode) and the holes from positive electrode (anode) will flow into this layer and recombine inside the layer to cause light emitting. Practically, however, no such a light emitting material can yield an efficient conversion from carriers to photons under this simple structure. This is because the light emitting materials are often ineffective in extracting charge carriers from the electrodes and in transporting both charge carriers so that the holes and electrons are met and recombined to release photons. Because it takes an electron hole pair (one electron and one hole) to recombine to generate one photon, light generation is limited by the densities of the two types of populated charge carriers (electron or hole). The extra charge carriers of the one with higher density are wasted without recombining with the less populated charge carriers.

Since the efficiency of light generation is limited by the density of the less populated charge carrier, when the respective density of the electrons and holes are more or less equal (balanced) in the emission layer, the chance of a radioactive recombination is maximized. Therefore, to have an effective electro-luminescent device, not only it is required for charges to be extracted and transported from the electrodes to the desired recombination sites effectively, but it is also essential to achieve a balance between the positive charge density and the negative charger density.

FIG. 1 illustrates an OLED device (10) of the simplest structure where a minimum of three organic materials are needed to form the device. The OLED (10) consists of a cathode (11), a hole-transport layer (12), a light emitting layer (13), an electron-transport layer (14) and an anode layer (15). The OLED device (10) is generally not very efficient in converting electricity to light. In order to improve the efficiency of the multilayer OLED device (10), more layers of organic materials are inserted into this simple three layer structure. FIG. 2 presents a multilayer OLED device (20) with 7 layers of organic materials. The OLED (20) consists of a cathode (21), a hole injection layer (22), a hole-transport layer (23), an electron blocking layer (24), a light emitting layer (25), a hole blocking layer (26), an electron-transport layer (27), an electron injection layer (28) and an anode layer (29).

From above description, it is obvious that if an OLED panel can be prepared in a single layer configuration without sacrificing the performance of the device, the throughput and the final cost of the product will be greatly reduced. Furthermore, because OLED devices with this single layer structure can be created in a non-vacuum process, further reduction of the cost is expected.

### OBJECT OF THE INVENTION

One objective of the present invention is to provide all-in-one organic electroluminescent inks for the fabrication of single-layer OLED devices. Another objective of the present invention is to provide methods to achieve a balanced charge injection in an all-in-one organic ink by selecting materials and adjusting the relative concentration of the negative charge-transport component and the positive charge-transport component in the all-in-one organic electroluminescent ink. Yet another objective of the present invention is to provide a method to improve the morphology of an all-in-one organic film by adding a binding component into the all-in-one organic electroluminescent ink. Still another objective of the invention is to provide a solution process to fabricate single-layer OLED devices by using the all-in-one organic electroluminescent inks.

### BRIEF DESCRIPTION OF THE DRAWINGS

FIG. 1 shows a schematic representation of a prior-art OLED structure (10) of 3 layers.

FIG. 2 illustrates a schematic representation of a prior-art OLED device (20) of 9 layers.

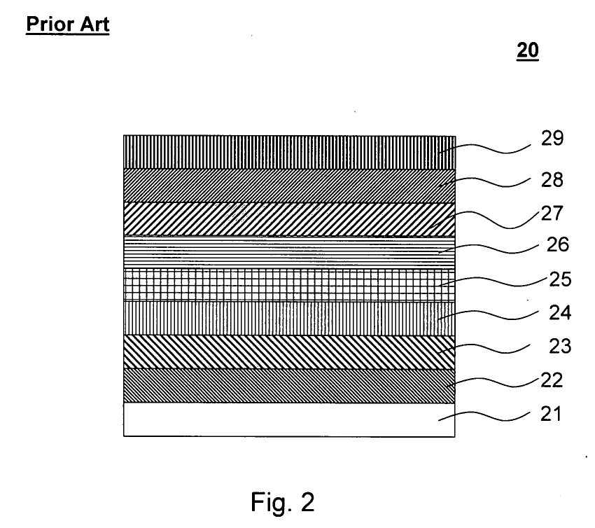

FIG. 3 shows schematic representation of a single-layer OLED structure (30) made from an all-in-one organic electroluminescent ink according to the present invention.

FIG. 4 shows the current-voltage characteristics of an all-in-one single-layer green OLED device prepared by an all-in-one green ink (GRN-INK-1) according to this invention.

FIG. 5 illustrates the spectrum of the output light from the all-in-one single-layer green OLED device shown in FIG. 4 at different forward bias voltage.

FIG. 6 shows the current-voltage characteristics of an all-in-one single-layer red OLED device prepared by an all-in-one red ink (RED-INK-3) according to this invention.

FIG. 7 illustrates the spectrum of the output light from the all-in-one single-layer red OLED device (shown in FIG. 6) at different forward bias voltage.

### DETAILED DESCRIPTION OF THE PREFERRED EMBODIMENTS

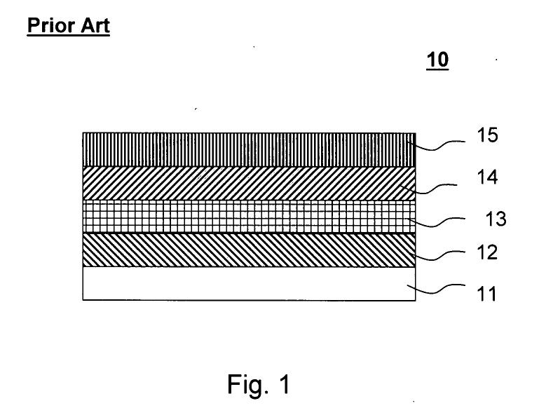

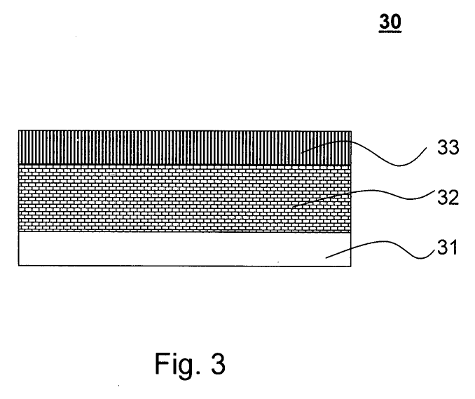

One distinguishing feature of this invention is to integrate the two charge transport layers into the light emitting layer. Therefore, the three separate layers (12, 13, and 14) in FIG. 1 become one layer (32) as schematically depicted in FIG. 3. Another unique feature of the present invention is to combine the charge transport materials and the light emitting material into a combined single solution (ink), which can be processed to form a uniform film between the two electrodes and allows one to make a single layer OLED device by means of a non-vacuum solution process. By adjusting the relative weight ratio of the electron-transport component and the hole-transport component in the combined single solution (ink), when the layer (32) is formed between two specific contact materials, a charge balance can be obtained. This unique combined single solution (ink) with the balanced charge transport properties is called all-in-one organic electroluminescent ink.

According to one embodiment of the present invention, the all-in-one organic eletroluminescence ink consists of at least 5 components: the positive charge transport component, the negative charge transport component, the electroluminscent component, the binding component and the solubilizing component. This ink can be coated or printed onto an electrode and form a uniform organic layer after the solubilizing component is removed. An OLED device can then be completed by placing a second electrode onto this single all-in-one organic layer. Another embodiment of this invention is to achieve a balanced charge transport properties in an all-in-one organic electroluminescent ink by selecting materials for various components and by adjusting the relative concentrations of the components in this all-in-one organic electroluminescent ink.

The function of the solubilizing component is to provide a media or carrier for other components and to allow them to be soluble in the solubilizing component at a preferable concentration. The solubilizing component carries other components onto a surface (an electrode at this case) to form a uniform film after the removal of the solubilizing component by heat, vacuum or combination of the two. Materials for the solubilizing component are selected based on some basic properties including polarity, boiling point and viscosity.

Some examples of the preferred solubilizing component include toluene, o-xylene, cholorobenzene, 1,2-diclorobenzene, cyclohexanone, tetrahydrofuran (THF), dichloromethane (DCM), chloroform, isopropanol, trichloroethylene (TCE), dimethylformide (DMF), and other common solvents or a mixture of two or three common solvents. In the single solvent case, it is preferred to use a solvent with boiling point higher than 373 K. If a solvent with low boiling point is selected, it is preferred to combine another solvent of higher boiling point.

The function of the binding component is to provide viscosity and stability to the all-in-one ink and consequently to improve the morphology of the deposited film. A binding component can be selected to be a single organic material or a mixture of organic materials. Preferably, a transparent polymer or a mixture of several transparent polymers can be chosen to serve as the binding component.

The binding component can also be advantageously selected to have charge transport properties. Some examples of such materials are polyfluorence (PF), polyvinyl-carbazole (PVK) and poly-paraphenylene (PPP). If a charge transport polymer is selected as the binding component, its charge transport property will add to the properties of the charge transport component.

A preferred polymeric binding component is electrically insulating, some material examples are polyethylene, polycarbonates, polyesters, polyamides, polyacrylates, polyacrylamides, polyethylene-glycols (PEG), polyureas, and Teflon. Since these polymeric binders are not electrically conductive, it is preferred to use minimum amount of binder in the all-in-one ink.

Another consideration is the solubility of these polymeric binders in the selected solubilizing component. If the binder is not soluble in the solubilizing component, one option is to use the corresponding monomers of these polymeric binders along with a small portion of polymerization catalysts. In this case, tone should use as less polymerization catalyst as possible as the catalyst left in the all-in-one ink can have unfavorable effect on the performance of the all-in-one devices.

The electroluminescent (or light emitting) component can be an organic compound or a mixture of organic compounds capable of emitting light when a charge recombination process occurs. These light emitting compounds can be of either phosphorescent emissive materials or of fluorescent emissive materials.

For the blue color, examples of the preferred fluorescent light emitting materials include but not limited to 4,4-Bis(2,2′-diphenylethenyl)-1,1′-biphenyl (DPVBi), 4,4′-Bis([2-[4-(N,N-diphenylamino)phenyl-1-yl]-vinyl-1-yl]-1,1-biphenyl (DPAVBi), 4,4′-Bis(9-ehtyl-3-carbazovinylene)-1,1′-biphenyl (BCzVBi), 4,4′-bis[4-(di-p-toylamino)styryl]Biphenyl(IDE102)), 9,10-dinathalene-anthrance (DNA), B-Blue, and Bis(2-methyl-8-quinolinolato)-4-(phenyl-phenolato)aluminum(III) (B-Alq).

For the green color, examples of some of the preferred fluorescent light emitting materials include but not limited to Tris(8-quinolato)aluminium(III)(AlQ₃), Bis(8-quinolato)zinc(II)(ZnQ), Tris(3-methyl-1-phenyl-4-trimethylacetyl-5-pyrazoline)terbium (III), coumarines (C545T, C545TB, C545MT, C545P), quinacridines, indono(1,2,3-cd)perylenes, and rubrenes.

For the red color, examples of some of the preferred fluorescent light emitting materials include but not limited to 4-(dicyanomethylene)-2-methyl-6-(p-dimethylaminostyryl)-4H-pyran(DCM), 4-(dicyanomethylene)-2-methyl-6-(julolidine-4-yl-vinyl)-4H-pyrane)(DCM2), 4-(Dicyanomethylene)-2-tert-butyl-6(1,1,7,7,-tetramethyljulolidyl-9-enyl)-4H-pyran(DCJTB), NPAFN, BSN, squaraine, and europium-complexes (Eu(DBM)2(HPBM), Eu(DBM)3(TPPO)).

Fluorescent emissive materials may also be preferably selected from macromolecules, examples of which include but not limited to polyfluorences (PF), poly phenyl-vinylenes (PPV), polythiophenes(PT), and poly-para-phenylenes (PPP).

Some examples of preferred phosphorescent emissive materials are Tris(2-phenylpyidine)iridium (Ir(ppy)₃), Iridium(III) tri(1-phenyl-isoquinolinato-C²,N)Ir(Piq)3, Iridium(III) bis(1-phenyl-isoquinolinato-C²,N) acetylacetonate (Ir(piq)2acac), Iridium(III) bis(2-(4,6-diflurophenyl)pyridinato-N,C²)picolinate (Firpic), Iridium (III) bis(2-(2′-benzothienyl)pyridinato-N,C³)acetylacetonate (btp)2Ir(acac), and Platinum(II) octaethylporphrin.

Positive charge (hole) transport component may include a organic compound or a mixture of organic compounds capable of transporting positive charges (holes). The hole-transport capability of a material is described by hole mobility value of the material. The hole-transport component should have a hole mobility in a range of 1×10⁻¹² to 1×10² cm²/V-sec, more preferably in a range of 1×10⁻⁶ to 1×10² cm²/V-sec. Another important parameter is the energy gap of the selected hole-transport component. In order to avoid undesired energy transfer from the light emitting component to the hole-transport component, it is preferred to have the energy gap of the selected hole-transport component greater than that of the light emitting component, with an energy gap difference of 0.1-2.0 eV (more preferably 0.2-1.0 eV).

The hole-transport compound can be either a small molecule or a macromolecule material. Most conducting polymers have hole-transport properties. Some common conducting polymers are polyanilines (PAs), polythiophenes (PTs, ie PEDOT, P3HT), poly-paraphenylenes (PPP), polyphenylvinyls (PPV), polyfluorenes (PFs) and polyvinyl-carbazole (PVK). Small molecules with hole-transport properties are often conjugated molecules containing nitrogen compounds. 4,4′-Bis[N-(1-naphthyl)-N-phenyl-amino]biphenyl(α.-NPB), N,N′-diphenyl-N,N′-bis(3-methylphenyl)1-1′biphenyl-4,4′diamine(TPD), 4,4′-Bis(carbazol-9-yl)biphenyl(CPB), 4,4′,4″-Tris(2-naphthylphenylamino)triphenylamine (TNATA), Tris(N-carbazolyl)triphenylamine (TCPA), N,N′-bis[4′-[bis(3-methylphenyl)amino] [1,1′-biphenyl]-4-yl]-N,N′-diphenyl-[1,1′-biphenyl]-4,4′-diamine (TPTE), Bis[9-(4-methoxyphenyl) carbazol-3-y], 1,1-bis(4-bis(40methyl-phenyl)amino-phenyl)cyclohexane (TAPC), and Cupper phthalocyanine (CuPC) are some of the examples.

Negative charge (electron) transport component is an organic compound or a mixture of organic compounds capable of transporting electrons. Electron-transport capability of a selected compound or a mixture of selected compounds is measured by its electron mobility. The electron mobility of an electron-transport compound or a mixture of electron-transport compounds should be in a range of 1×10⁻¹² to 1×10² cm²/V-sec, more preferably in a range of 1×10⁻⁸ to 1×10² cm²/V-sec. Another property is the energy gap of the electron-transport component. In order to avoid unwanted energy transfer from the light emitting component to the electron-transport component, it is preferred to have the energy gap of the selected electron-transport component greater than that of the light emitting component, with an energy gap difference in a range of 0.1-2.0 eV (more preferably in a range of 0.2-1.0 eV).

Electron-transport component can be selected from material groups such as fluorine atoms, cyano groups, triazole groups, oxadizole groups. Some material examples for the electron-transport component include but not limited to 1,3,5-tris(4-fluorobiphenyl-4′-yl)benzene(F-TBB), 3-(4-biphenylyl)-4-phenyl-5-tert-butylphenyl-1,2,4-triazole(TAZ,butyl-PBD), 2,2′-(1,3-phenylene)bis{5-[4-(1,1)dimethylethyl)phenyl) 1,3,4-oxadiaole (OX-7), 1,4-bis(4-(4-diphenylamino)-phenyl-1,3,4-oxadiaole-2yl)-benzene, 1,3-bis(4-(4-diphenylamino)-phenyl-1,3,4-oxadiaole-2yl)-benzene, 7,7,8,8-tetracyano-quinodimethane(TCNQ), 7,7,8,8-tetracyano-2,3,5,6-tetrafluoroquinodimethane(F4-TCNQ), 11,11,12,12-tetracyanonaththo-2,6-quinodimethane(TNAP), and AlQ3.

The electron-transport materials may be fullerenes and its derivatives, such as C60 and C70. To make it soluble in the selected solubilizing component, the derivatives with branched hydrocarbons are preferred. The preferred compounds in this category include but not limited to 1-[3-(methoxycarbonyl)propyl]-1-phenyl-[6.6]C61(PCBM-C60), and 1-[3-(methoxycarbonyl)propyl]-1-phenyl-[6.6]C71(PCBM-C70).

It is noted that both the electron-transport component and hole-transport component may also have electroluminescent properties. For example, AlQ3, an effective electron-transport material emits green light efficiently and DPVBi, a hole-transport material emits blue light. In these cases, the electron-transport component or hole-transport component can also function as the light emitting component.

The charge balance of the all-in-one ink is achieved through material selections and by adjusting relative concentration in the all-in-one ink for each of the five components. To define the relative concentration of each component, one can take the light emitting component as a reference and use the ratio between another component to it as a measure of relative composition for given component. Unless otherwise specified, the ratio in weight is used throughout this text to simplify the formulation.

An all-in-one organic electroluminescent ink with balanced charge transport properties can be applied onto a substrate by solution processes and followed by removal of the solubilizing component to form a film. Some example of the solution processes are spin-coating, dip-coating, screen printing and inkjet printing. Thickness, uniformity and morphology of the film is determined by material type and the amount used for each component in the all-in-one ink.

The binding component plays an important role in film morphology and uniformity. When a binder is selected to have very poor charge-transport or light-emitting properties, it serves as a dilutor to other organic semiconductors. In such case, its concentration should be minimized. The concentration ratio of the binder to the light emitting component in the all-in-one ink is generally preset to be 0.1-5.0 (more preferably 0.5-1.0).

As soon as the all-in-one ink is deposited onto the substrate, the solubilizing component is removed to form the film. The composition of the solubilizing component is therefore not to contribute to the film composition which determines the performance of the final OLED device. However, its concentration may affect the thickness and uniformity of the film. According the present invention, the ratio of the solubilizing component to the light emitting component is selected in the range of 20 to 500 (more preferably from 50 to 200).

The ratio of total concentration of the charge transport components (hole-transport component and electron-transport component) to the concentration of the light emitting component in a range of 0.2 to 10, more preferably 0.5 to 2 may be used. The individual concentration of the electron-transport component and the hole-transport component is adjusted so that charge balance is achieved when the device is fabricated. In these preferred embodiments. The concentration of the light emitting component in respect to that of the total charge transport components is corresponding to a ratio of 0.5 to 2, which differs from any doping case where the light emitting material is often kept at a concentration below 20% in respect to the host matrix.

### EXAMPLES

In the following examples, commercially available chemicals are purchased from Sigma-Aldrich unless otherwise specified. Compounds not available commercially are synthesized in Organic Vision Inc., and will be described in the first three examples of this invention. Ratios in weight are used throughout the text unless otherwise specified. All-in-one organic light emitting diodes emitting light at different spectrum are fabricated to demonstrate the wide usefulness of the present invention. Both singlet and triplet light emitting materials are employed to further demonstrate the same.

The following are only representative examples and are described hereby to demonstrate the wide range of possibilities this invention covers, by which we can employ the principle to construct all-in-one organic light emitting diodes with balanced charge properties. It is further acknowledged that the formations of the hereto-described examples may similarly be made with different hole-transport material, electron-transport material, light emitting material, binding material, solvents and electrode materials. Concentrations of each material can be adjusted to control the thickness and uniformity of the all-in-one organic layer.

### Example 1

### Synthesis of an Electro-Luminescent Compound, DPVBi

### 4,4′-Bis[(diethyl phosphate)methyl]biphenyl

Under nitrogen atmosphere, 25.12 g of 4,4′-bis(chloromethyl)-1,1′-biphenyl (100 mmol.) and 100 ml of triethyl phosphite were charged together in a dried 3-neck flask (250 ml) equipped with a reflux condenser, a gas inlet, and an electronic thermometer. It immediately caused a beige suspension. The suspension was heated and stirred for two hours at 130° C. The solution was continued to be stirred for another four hours at 130° C. After it cooling down to room temperature, it was kept in a refrigerator for overnight. The resulting gray precipitate was filtered, thoroughly washed with cool hexane (5×50 ml), and dried under suction and then put in a vacuum oven for two hours at 65° C. Finally, 39.43 g of a beige crystal was collected (86.8%).

### Characterization of the Crystal:

m.p.: 103-109° C.

FTIR (KBr, cm⁻¹): 3041, 2980, 14995, 14405, 1392, 1245, 1035, 961, 864, 831, 772, 736, 592, 564, 533.

¹HNMR(CDCl₃, δ) 7.0-7.6 (m, 8H), 3.1 (d, 4H), 4.0 (q, 8H), 1.3 (t, 12H).

### 4,4-Bis(2,2′-diphenylethyenyl)-1,1′-biphenyl (DPVBi)

A 1,000 ml 3-neck flask was heated with propane flame while N₂ was passed through. The N₂ flow was kept for 30 minutes during which time the flask was allowed to cool down to room temperature. Under N₂ flow, 22.72 g of 4,4′-bis[(diethyl phosphate)methyl]-1,1′-biphenyl (50.0 mmole, 1.0 eq., obtained from the last step) and 27.33 g of benzophenone (150.0 mmole, 3.0 eq.) were dissolved in 500 ml of THF. Into the resulting yellow solution, 16.83 g of potassium tert-butoxide (150.0 mmole, 3.0 eq.) was added. The resulting solution was stirred overnight at room temperature. The mixture was concentrated by rotary evaporation till about 150 ml of liquid residue was left. The residue was slowly poured into 500 ml of well-stirred methanol. The resulting yellow precipitates were filtered, washed with 3×100 ml of methanol, 3×100 ml of water, and 3×100 ml of methanol, and dried under suction and then put in a vacuum oven overnight at 65° C. Finally, 20.81 g of yellow powder was obtained (yield: 81.5%). The crude product was re-crystallized in ethanol before sublimation. The sublimation was carried out by using a train sublimator at a temperature of 200° C.

The final purified product was analyzed by spectroscopic analysis and elemental analysis and the results are shown below:

¹HNMR(CDCl₃): 6.7-7.3 ppm (m, 30H, terminal phenyl ring-H, central biphenylene and methylidine ═C═CH—)

FTIR (KBr, cm⁻¹): 1520, 1620 (ν_{C—C})

MS m/z=510

Elemental Analysis: C, 94.15% (94.08%), H, 5.9 (5.92%), N, 0.00% (0%)

Confirmed structure: 4,4-Bis(2,2′-diphenylethyenyl)-1,1′-biphenyl (DPVBi)

### Example 2

### Synthesis of Electron-Transport Component, OVI588

### 1,3,5-tris(4-flluorobiphenyl-4′-yl)benzene

In 3-neck round-bottom flask (250 ml) filled with nitrogen, 100 ml of freshly-distilled THF and 20 ml of de-ionized water were poured and degassed with nitrogen bubbles for 30 minutes. 0.78 g of tetramethylamonium bromide was added as a phase transfer agent. 0.33 g of palladium acetate and 1.8 g of triphenylphosphine were added and the resulting suspension was stirred for a half of hour to activate the catalysts. 2.42 g of 1,3,5-tris(4-bromophenyl)benzene and 2.65 g of 4-fluorophenylboronic acid were then added and the resulting mixture was heated to reflux before adding 7.2 g of sodium carbonate. The solution was heated to reflux for 48 hours to complete the reaction. After cooled down to room temperature, the reaction mixture was transferred into a separation funnel and water was separated. The separated organic layer was again washed by water (2×20 ml) and dried with sodium sulfate and by rotary evaporation and 4 g of crude product of 1,3,5-tris(4-flluorobiphenyl-4′-yl)benzene (OVI588) was collected. This crude product was further purified by silica gel column chromatography using toluene/hexane as an eluent and 1.7 g of the final product was obtained.

### Example 3

### Synthesis of Hole-Transport Material, OVI544

### 9-(4-methoxyphenyl)carbazole

A 1,000 ml 3-neck flask equipped with a Dean Starks trap, a water condenser and a magnetic stirrer was flame dried with a torch under nitrogen and cooled down to room temperature. 300 ml of anhydrous o-xylene was poured into the flask and degassed with nitrogen bubble for 30 minutes. 41.8 g of carbazole and 58.51 g of 4-iodoanisole were added and heated to yield a clear brown solution. 2.48 g of copper chloride and 4.5 g of 1,10-phenanthroline were then added, followed by 14.1 g of potassium hydroxide. After refluxed for 3 hours, another 14.1 g of potassium hydroxide was added and the resulting mixture was continued to reflux for another 20 hours and it was cool down to room temperature. After the reaction mixture was transferred into a separation funnel, it was washed by water (3×100 ml), dried with sodium sulfate and filtered to yield 46.3 g of flakes. 39.5 g of final product was obtained after a re-crystallization step. Spectroscopic characterization confirm the chemical structure of this beige flake was 9-(4-methoxyphenyl)carbazole.

### Bis[9-(4-methoxyphenyl) carbazol-3-yl] (OVI544)

Into a solution of 13.7 g 9-(4-methoxyphenyl)carbazole (from last step) in 350 ml chloroform, 16.5 g of iron(III) chloride was added. After stirring at room temperature for 24 hours, 300 ml of water was added. The organic layer was separated, washed, dried, filtered and evaporated to yield 11.9 g of powder. The powder was then re-crystallized to give 8.4 g of off-white powder. The powder was further purified by sublimation at a temperature of 573 K and a pressure of 1×10⁻⁵ torr to yield 5.5 g of white crystal. The melting point of the crystal was found to be 486-487 K. Spectroscopic characterization confirm the chemical structure of the crystal was: bis[9-(4-methoxyphenyl) carbazol-3-yl] (OVI544).

### Example 4

### All-in-One Blue Fluorescent Solution with Balanced Charge Properties

An all-in-one blue fluorescent ink with balanced charge properties was prepared in a composition specified in Table-1, where relative concentration of a component is given by the weight ratio between the component and the light emitting material.

TABLE 1
Composition of an all-in-one blue ink BLU-INK-1

| | Chemical Name | Relative | |
|---|---|---|---|
| Component | Abbreviation | Concentration | Note |
| Light emitting | DPVBi | 1 | Example 1 |
| Electron-transport | OVI588 | 1 | Example 2 |
| Hole-transport | OVI544 | 1 | Example 3 |
| Binding | PVK | 1 | |
| Solubilizing | THF | 100 | |
| | Toluene | 100 | |

After weighed proportionally and mixed all components listed in table-1 in a clean flask, the mixture was stirred for 10 hours to yield a clear solution. This solution was then carefully filtered through a Whatman glass microfiber filter (Grade GF/F) into another clean flask to produce the final all-in-one blue fluorescent ink BLU-INK-1.

Single-layer organic light emitting diodes are fabricated using the all-in-one blue fluorescent ink (BLU-INK-1) to examine the performance of the all-in-one ink. A commercially available ITO-coated glass (Colorado Concept Coating LLC) was cut and thoroughly cleaned. The substrate is then patterned by a conventional photolithographic and wet etching process to remove unwanted the ITO films. Following the removal of the photoresist layer, the substrate is then cleaned and prepared for device fabrication.

A layer of the all-in-one blue fluorescent (BLU-INK-1) was spin-coated onto the patterned ITO-coated glass at about 1000 rpm. The solubilizing component was then removed by heating the substrate at 100° C. in air for 5 minutes to yield a uniform layer of organic materials. Then, a thin layer of aluminum was thermally evaporated onto this organic layer to complete the final OLED device with a configuration of Al/all-in-one organic/ITO.

When a DC voltage is applied between the anode (ITO) and the cathode (Al) of the all-in-one OLED device, uniform and bright blue light was observed. For comparison purposes, devices with a structure of Al/DPVBi/ITO were also fabricated. These diodes consist of a single light emitting organic layer (DPVBi) without the charge transport components listed in Table-1. When a DC voltage is applied to the diodes, no light output is observed.

### Example 5

### All-in-One Green Fluorescent Ink with Balanced Charge Properties

Similar to the all-in-one blue ink BLU-INK-1, an all-in-one green fluorescent ink GRN-INK-1 with balanced charge properties was prepared and tested through single-layer OLED device fabrication. The all-in-one green ink GRN-INK-1 was prepared in a composition specified in Table-2, where relative concentration of a given component is determined by the weight ratio between the component and the light emitting material. The OLED fabrication detail is described in Example 4.

TABLE 2
Composition of an all-in-one green ink GRN-INK-1

| | Chemical Name | Relative | |
|---|---|---|---|
| Component | Abbreviation | Concentration | Note |
| Light emitting | AlQ3 | 1 | |
| Electron-transport | OVI588 | 1.5 | Example 2 |
| Hole-transport | α-NPB | 0.5 | |
| Binding | PVK | 1 | |
| Solubilizing | DCM | 100 | |
| | Cyclohexanone | 100 | |

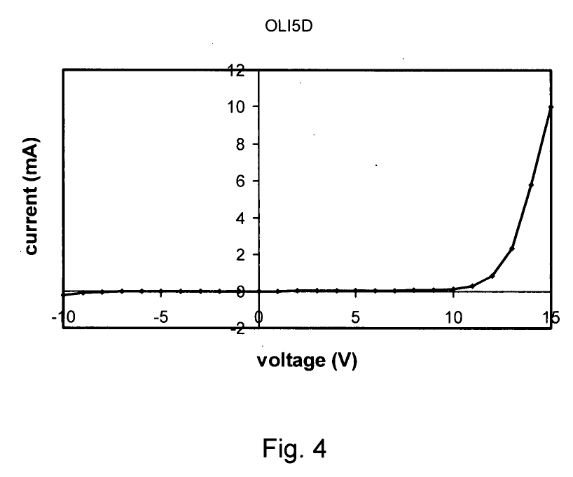

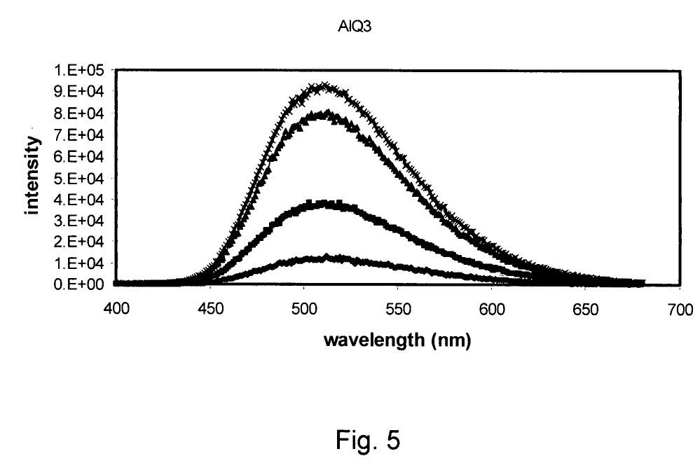

When a DC voltage is applied between the anode (ITO) and the cathode (Al), uniform and bright green light was observed. Current-voltage characteristics of a typical all-in-one green OLED is measured and shown in FIG. 4. It is shown that the device exhibits good rectification characteristics with minimum leakage when reverse biased. The spectrum of the light output from the same green OLED device at different forward bias voltage is measured using a photo spectrum apparatus and the results are shown in FIG. 5. The relative intensity of the output light increases as the bias voltage is increased. The peak intensity of this device is observed at 506 nm which is essentially at the same wavelength as that of an evaporated multilayer OLED device fabricated in-house and reported in literature.

For comparison purpose, devices with structure of Al/AlQ3/ITO were also fabricated. These diodes consist of a single light emitting organic layer (AlQ3) without the charge transport components. When a DC voltage is applied to the diodes, no light output is observed.

### Example 6

### All-in-One Green Phosphorescent Ink with Balanced Charge Properties

TABLE 3
Composition of all-in-one green ink GRN-INK-3

| | Chemical Name | Relative | |
|---|---|---|---|
| Component | Abbreviation | Concentration | Note |
| Light emitting | Irppy | 1 | |
| Electron-transport | Butyl-PBD | 1 | |
| Hole-transport | α-NPB | 1 | |
| Binding | PVK | 1 | |
| Solubilizing | DCM | 100 | |
| | Cyclohexanone | 150 | |

A triplet emitter (Irppy) was used to prepare an all-in-one green phosphorescent ink GRN-INK-3. Table-3 lists the composition of the ink, where relative concentration of a given component is determined by the weight ratio between the component and the light emitting material. The performance of the all-in-one green ink GRN-INK-3 is tested through single-layer OLED device fabrication (device structure: Al/all-in-one GRN-INK-3/ITO; fabrication process: similar to the one described in Example 4). When a DC voltage is applied between the anode (ITO) and the cathode (Al), uniform and bright green light was observed. For comparison purpose, devices with structure of Al/Irppy/ITO were also fabricated. These diodes consist of a single light emitting organic layer (Irppy), without the charge transport compounds, sandwiched between the anode and the cathode. When a DC voltage is applied to the two electrodes, no light output is observed.

### Example 7

### All-in-One Red Phosphorescent Ink with Balanced Charge Properties

An all-in-one red phosphorescent ink (RED-INK-3) with balanced charge transport properties was prepared in a similar manner as described in Example 4. The composition of the all-in-one red phosphorescent ink (RED-INK-3) is listed in table-4, where relative concentration of a given component is given as the weight ratio between the component and the light emitting material. This all-in-one red ink was tested through single-layer OLED device fabrication (device structure: Al/all-in-one RED-INK-3/ITO; fabrication process: similar to the one described in Example 4).

TABLE 4
Composition of all-in-one red ink RED-INK-3

| | Chemical Name | Relative | |
|---|---|---|---|
| Component | Abbreviation | Concentration | Note |
| Light emitting | (btp)2Ir(acac) | 1 | |
| Electron-transport | OVI588 | 1.71 | Example 2 |
| Hole-transport | α-NPB | 0.29 | |
| Binding | PVK | 1 | |
| Solubilizing | DCM | 200 | |
| | Cyclohexanone | 100 | |

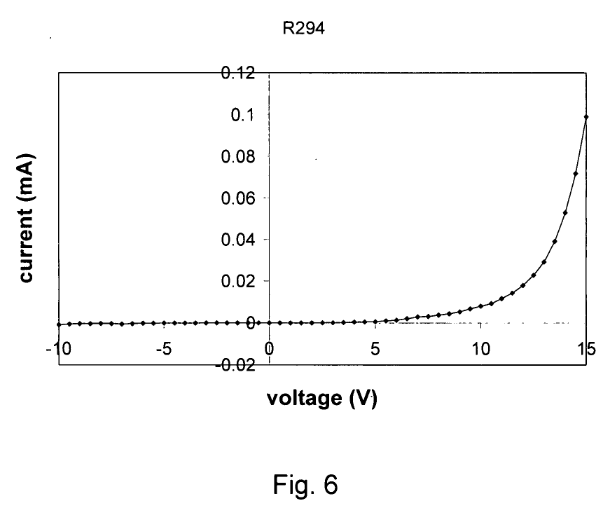

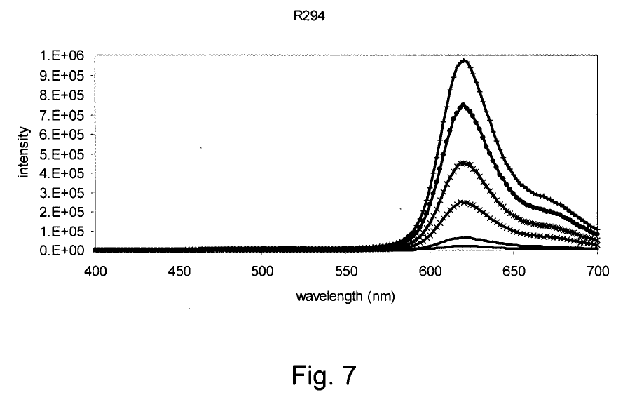

When a DC voltage is applied between the anode (ITO) and the cathode (Al), uniform and bright red light was observed. Current-voltage characteristics of a typical all-in-one single-layer red OLED device is measured and shown in FIG. 6. It is seen that the device exhibits good rectification characteristics with minimum leakage in the reverse bias. The spectrum of the output light from the OLED at different forward bias voltages is measured using a spectrum apparatus and the results are shown in FIG. 7. The peak intensity of this device is observed at 620 nm which is essentially the same peak wavelength for the evaporated multilayer OLED devices fabricated in-house and reported in literature.

For comparison purpose, single-layer devices were also fabricated with (btp)2Ir(acac) ink with no charge transport components. When a DC voltage is applied to these diodes, no output light is observed.

### Example 8

### Effects of Charge Balance on the Performance of an All-in-One Green Fluorescent Ink

This example is designed to demonstrate the effects of charge balance on the performance of all-in-one electroluminescent inks. Single-layer devices are fabricated using all-in-one inks with varied relative composition of the hole-transport component with respect to the electron-transport component (see table 5).

TABLE 5
Composition variation of hole-transport component and
electron-transport component in all-in-one green inks

| | Chemical Name | Relative Weight | |
|---|---|---|---|
| Component | Abbreviation | Ratio | Note |
| Light emitting | AlQ3 | 1 | |
| Electron-transport | OVI588 | 0.05 to 1.67 | Example 2 |
| Hole-transport | α-NPB | 0.05 to 0.8 | |
| Binding | PVK | 1 | |
| Solubilizing | DCM | 100 | |
| | Cyclohexanone | 100 | |

A constant concentration is kept for both the light emitting component (AlQ3) and the binding component (PVK) with respect to the concentration of the solubilizing components. The weight ratio of the electron-transport material is varied from 0.05 to 1.67 with respect to the weight of the light emitting component and the weight ratio of the hole-transport components is varied from 0.05 to 0.8 with respect to the light emitting component. For most of the devices in example 8, the relative weight ratio between the hole-transport component and the electron-transport component is varied from 1:1 to 1:10 and the weight ration between the combined transport components and the light emitting component is varied from 0.1:1 to 1:2.4.

All devices with the composition described in the previously paragraph generate green light when a large enough dc bias is applied to the electrodes. Different threshold voltages are nonetheless observed on devices made of inks with different charge transport component concentrations. On the other hand, under the same bias voltage, the output light intensity is observed to vary extensively amongst the diodes with different charge transport component concentrations.

The testing results of some all-in-one single-layer devices fabricated using inks with different component concentrations are listed in Table-6. From the previous examples, we have known that the charge transport material is required to have a working all-in-on OLED device. Therefore certain amount of transport materials in the all-in-one layer is essential to have good charge transport property. As an example, Sample No. 79 is made with very small amount of charge transport materials in the all-in-one ink and it does not emit light when biased.

TABLE 6
Effects of relative weight ratio of the three components
(light emitting, electron-transport, and hole-transport)
on the properties of the all-in-one green OLEDs

| Sample | Light | Electron- | Hole- | Threshold | Luminance |
|---|---|---|---|---|---|
| No. | Emitting | transport | transport | voltage (V) | (Cd/m²) |
| 79 | 1 | 0.05 | 0.05 | N.A. | N.A. |
| 87 | 1 | 0.33 | 0.67 | 18 | <10 |
| 99 | 1 | 0.67 | 0.33 | 12 | ~100 |
| 100 | 1 | 0.75 | 0.25 | 12 | ~100 |
| 101 | 1 | 0.80 | 0.20 | 12 | ~100 |
| 110 | 1 | 0.83 | 0.17 | 11 | >1000 |
| 111 | 1 | 0.91 | 0.09 | 11 | >1000 |
| 165 | 1 | 1.71 | 0.29 | 13 | >500 |
| 166 | 1 | 1.89 | 0.31 | 13 | >500 |

It is known that the hole mobility in the hole-transport material (α-NPB) is much greater than that of the electrons in the electron-transport material (OVI588). Therefore as a general rule, the concentration of the electron-transport material should be higher than that of the hole-transport material so that a negative and positive charge balance can be obtained. This explained the poor performance in Sample No. 87, which has a higher concentration of hole-transport component than that of the electron-transport component. When the concentration of the hole-transport component is increased to be larger than that of the electron-transport component, the threshold voltage of the OLED devices started to decrease and light output at constant current bias is increased.

Sample Nos. 110 and 111 demonstrate that when the weight concentration of the hole-transport component is reduced to be about ⅕ to 1/10 of that of the electron-transport material, the devices exhibit smaller threshold voltage and higher light output level. In general, good all-in-one devices with low threshold voltage and high output intensity are obtained when the weight ratio between the hole-transport and electron-transport component is kept at 1:5˜1:10 and the weight ration between the combined charge transport components and the light emitting component is kept at 2:1˜1:1.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

What is claimed is:

1. An all-in-one organic electroluminescent ink with balanced charge transport properties for optoelectronic device fabrication comprising:
a positive charge transport component,
a negative charge transport component,
an electroluminescent component,
a binding component, and
a solubilizing component.

2. An all-in-one organic electroluminescent ink with balanced charge transport properties as defined in claim 1, wherein said balanced charge transport properties are achieved by selecting materials for said positive and negative charge transport components and controlling concentration of each said charge transport component.

3. An all-in-one organic electroluminescent ink with balanced charge transport properties as defined in claim 1, wherein said positive charge transport component is an organic compound or a mixture of organic compounds having a higher hole mobility than electron mobility.

4. An all-in-one organic electroluminescent ink with balanced charge transport properties as defined in claim 1, wherein said negative charge transport component in claim 1 is an organic compound or a mixture of organic compounds having a higher electron mobility than hole mobility.

5. An all-in-one organic electroluminescent ink with balanced charge transport properties as defined in claim 1, wherein said electroluminescent component emits light under an electric field and is selected from a group of organic compounds and mixtures of organic compounds.

6. An all-in-one organic electroluminescent ink with balanced charge transport properties as defined in claim 1, wherein said binding component provides viscosity and stability to said all-in-one organic electroluminescent ink and is selected from a group of organic compounds and mixtures of organic compounds.

7. An all-in-one organic electroluminescent ink with balanced charge transport properties as defined in claim 1, wherein said solubilizing component is an organic compound or a mixture of organic compounds having the ability to dissolve said positive charge transport component, said negative charge transport component, said electroluminescent component and said binding component and having the ability to be removed completely or partially by heating or vacuum after said all-in-one organic electroluminescent ink is applied onto a substrate.

8. An all-in-one organic electroluminescent ink with balanced charge transport properties as defined in claim 1, wherein said positive charge transport component is functioning as said electroluminescent component.

9. An all-in-one organic electroluminescent ink with balanced charge transport properties as defined in claim 1, wherein said negative charge transport component is functioning as said electroluminescent component.

10. An all-in-one organic electroluminescent ink with balanced charge transport properties as defined in claim 1, wherein said binding component is functioning selectively as said electroluminescent component, said negative charge component and said positive charge component.

11. An all-in-one organic electroluminescent ink with balanced charge transport properties as defined in claim 1, further comprising applying said all-in-one organic electroluminescent ink onto a substrate by solution processes and removing said solubilizing component to form a uniform film, wherein said solution process includes spin-coating, dip-coating, screen printing and inkjet printing. Thickness and morphology of said uniform film is controlled by material selection for said binding component and by adjusting concentration of said binding component in said all-in-one ink.

12. An all-in-one organic electroluminescent ink with balanced charge transport properties as defined in claim 1, wherein optoelectronic device is a single layer organic light emitting diode with low operating voltage and high power efficiency.
